(19) United States
(12) Patent Application Publication
(10) Pub. No.: US 2005/0238859 A1
(43) Pub. Date: Oct. 27, 2005

(54) Metal member-buried ceramics article and method of producing the same

(76) Inventors: Tomonori Uchimaru, Hatano City (JP); Atsushi Arai, Hatano City (JP); Shigeko Muramatsu, Torrance, CA (US); Shinichiro Aomura, Hatano City (JP); Mitsuhiro Fujita, Hatano City (JP); Susumu Kimijima, Hatano City (JP); Keisuke Watanabe, Hatano City (JP)

Correspondence Address: FOLEY AND LARDNER;SUITE 500, 3000 K STREET NW, WASHINGTON, DC, 20007, US

(21) Appl. No.: 11/076,038

(22) Filed: Mar. 10, 2005

(30) Foreign Application Priority Data
Sep. 8, 2004 (JP) 2004-260612
Dec. 15, 2003 (JP) 2003-416698

(51) Int. Cl. C04B 35/581; B32B 15/00

(52) U.S. Cl. 428/209; 501/98.4; 428/698

(57) ABSTRACT

A metal member-buried ceramics article which can uniformalize adsorption force or adsorption force and distribution of temperature in plane, decrease pollution of a semiconductor wafer, and suppress warping of the whole body is provided. This article has a three layer structure comprising, between an upper layer 2 and a lower layer 3 composed of an AlN sintered body in the form of plate, an intermediate connecting layer 4 having a thickness of 0.5 to 10 mm composed of a sintered body of defatted AlN powder and a metal electrode 5 in contact with the inner surface of the upper layer or lower layer or a metal electrode in contact with the inner surface of the upper layer and a metal electric resistor in contact with the inner surface of the lower layer sandwiched between them, and has means for suppressing a stress remaining in sintering the defatted AlN powder.

### BACKGROUND OF THE INVENTION

1. Field of the Invention

The present invention relates to a ceramics article having buried metal members such as a metal electrode and/or metal electric resistor and the like, such as an electrostatic chuck and plate heater used in processes for producing semiconductors (CVD, PVD, ion sputtering, etching and the like), and a method of producing the same.

2. Description of the Related Art

Conventionally, as this kind of metal member-buried ceramics article, there is known an electrostatic chuck having a first substrate composed of an AlN (aluminum nitride) sintered body having an electrode layer formed, a second substrate composed of an AlN sintered body connected to the electrode forming surface of the first substrate, and a connecting layer provided on the whole surface between the first and second substrates and containing yttrium aluminate, as described, for example, in Japanese Patent Application Laid-Open (JP-A) No. 2000-216232.

The above-mentioned electrostatic chuck is produced by providing a green sheet composed of two or more of aluminum oxide, yttrium oxide and yttrium aluminate or of yttrium aluminate as a connecting material between a first substrate composed of an AlN sintered body having an electrode formed and a second substrate composed of an AlN sintered body, and conducting heat treatment while pressing them to melt connecting materials in the green sheet and to connect both the substrates.

However, with the electrostatic chuck and the method of producing the same described above, an electrode layer is formed on an AlN sintered body, consequently, an insulating dielectric layer of uniform thickness can be formed, however, a green sheet is sandwiched between the AlN sintered bodies, resultantly, it is difficult to defat the center part of the green sheet containing a large amount of organic binders.

For example, a specimen of 50 mm square size can be defatted, while a round specimen of 300 mm diameter cannot defatted at the center part.

Additionally, defatting cannot be conducted in air since a metal electrode is buried, as a result, conducted under an inert gas atmosphere such as a nitrogen gas and the like or under a vacuum atmosphere, and an effect of a reaction of a binder with oxygen cannot be obtained, consequently, defatting does not progress easily.

Therefore, the amount of remaining carbon excesses 0.1 wt %, a semiconductor wafer is polluted in use thereof, and control of resistance becomes difficult.

Further, part of connecting materials are melted and diffused in an AlN sintered body, and integrated to connect AlN sintered bodies, therefore, it is difficult to uniformalize the thickness of a connecting layer due to irregularity of temperature in melting, the parallel degree of AlN sintered bodies lowers, requiring a post process.

Furthermore, there is a problem of warping of the whole body of a ceramics article due to a remaining stress. The following two points are main causes for occurrence of a remaining stress. (1) difference in temperature and difference in pressure between the center part and peripheral parts of a ceramics article at the maximum temperature, way of decreasing pressure in lowering temperature, temperature lowering speed, and the like, in pressing and heating, (2) difference in thermal expansion coefficient between materials having different production histories.

The remaining stress is larger in the cause (2) than in the cause (1).

As the metal member-buried ceramics article, there is also known a ceramics sintered body obtained by placing a supporting plate on a lower mold for mono-axial press molding, providing a raw material powder composed of a ceramics powder containing substantially no binder on the supporting plate, and conducting mono-axial press molding of the raw material powder under this condition to obtain a preliminary molded body, placing a metal part (metal member) on this preliminary molded body, then, providing the above-mentioned raw material powder so as to cover the metal part on the preliminary molded body, then, conducting mono-axial press molding of the preliminary molded body, metal part and raw material powder to obtain a molded body having a buried metal part, then, sintering this molded body, as described, for example, JP-A No. 10-264121.

In the above-mentioned ceramics sintered body, a raw material powder composed of a ceramics powder containing substantially no binder is used, therefore, there is no necessity to conduct defatting, and pollution of a semiconductor wafer as with the above-mentioned electrostatic chuck does not occur.

However, warping of a metal part increases in molding, irregularity in distance between a metal part and the surface of a ceramics sintered body increases, resultantly, irregularity of adhesion force increases with an electrostatic chuck and irregularity of distribution of temperature in plane increases with a plate heater.

Further, a sintered body of an AlN ceramics having a buried metal member shows irregularity in volume resistivity and decoloration.

Particularly in the case of a plate heater, it is necessary to prevent leak current flowing through an AlN sintered body to uniformalize the temperature of a wafer, and in the case of an electrostatic chuck, it is necessary to uniformalize the volume resistivity of an AlN sintered body to prevent irregularity of wafer adhesion force.

Additionally, when volume resistivity varies for every metal member-buried ceramics article, there are problems of decrease in the yield of a plate heater, electrostatic chuck and the like and quality management, consequently, it is necessary to control volume resistivity.

Occurrence of irregularity in volume resistivity is believed to be caused by a phenomenon that in calcination and hot press, constituent elements of a metal member are reacted with a binder in an AlN sintered body or oxygen in an AlN sintered body to form an oxide, and diffused.

As means for preventing diffusion of such a metal oxide into an AlN sintered body, it is known to form a molybdenum silicide phase which does not cause decomposition, phase change or the like and is very stable even at high temperatures as a diffusion preventing phase on the surface of a metal member, as described, for example, in Japanese Patent No. 3243214.

However, for forming a molybdenum silicide phase on the surface of a metal member, a pre-process using a heat treatment method and the like is necessary, and cost for producing a metal member-buried ceramics article is increased, and it is difficult to form a molybdenum silicide phase without defects on the surface of a metal member and molybdenum is diffused from a defect part.

### SUMMARY OF THE INVENTION

The present invention has a main object of providing a metal member-buried ceramics article which can uniformalize adsorption force or adsorption force and distribution of temperature in plane, decrease pollution of a semiconductor wafer, and suppress warping of the whole body, and a method of producing the same.

A first metal member-buried ceramics article according to the present invention for attaining the above-mentioned object has a three layer structure comprising, between an upper layer and a lower layer composed of an AlN sintered body in the form of plate, an intermediate connecting layer having a thickness of 0.5 to 10 mm (means 0.5 mm or more and 10 mm or less, applied also in the followings) composed of a sintered body of defatted AlN powder and a metal electrode in contact with the inner surface of the upper layer or lower layer or a metal electrode in contact with the inner surface of the upper layer and a metal electric resistor in contact with the inner surface of the lower layer sandwiched between them, and has means for suppressing a stress remaining in sintering the defatted AlN powder.

A second metal member-buried ceramics article according to the present invention for attaining the above-mentioned object has a three layer structure comprising, between an upper layer and a lower layer composed of an AlN sintered body in the form of plate, an intermediate connecting layer having a thickness of 2 to 20 mm composed of a sintered body of an AlN calcined body in the form of plate and a metal electrode in contact with the inner surface of the upper layer or lower layer or a metal electrode in contact with the inner surface of the upper layer and a metal electric resistor in contact with the inner surface of the lower layer sandwiched between them, and has means for suppressing a stress remaining in sintering the AlN calcined body.

It is preferable that the concentration of oxygen solid-soluted in an AlN crystal in the above-mentioned intermediate connecting layer is 0.5 wt % or less.

It is preferable that the above-mentioned means for suppressing a remaining stress gives a proportion of the thickness of the upper layer to the thickness of the lower layer of 1:1 to 1:4 or 1:10 or more.

A first method of producing a metal member-buried ceramics article according to the present invention for attaining the above-mentioned object comprises providing two AlN sintered bodies in the form of plate having means for suppressing a stress remaining in hot press and providing between them defatted AlN powder and a metal electrode in contact with the inner surface of one or another AlN sintered body or a metal electrode in contact with the inner surface of one AlN sintered body and a metal electric resistor in contact with the inner surface of another AlN sintered body, subjecting the resulted layered product to mono-axial press molding, then, hot-pressing the layered product.

A second method of producing a metal member-buried ceramics article according to the present invention for attaining the above-mentioned object comprises providing two AlN sintered bodies in the form of plate having means for suppressing a stress remaining in hot press and providing a metal electrode on either one of the AlN sintered bodies, filling thereon defatted AlN powder and performing first mono-axial press molding, then, providing another AlN sintered body on the press-molded defatted AlN powder and performing second mono-axial press molding, thereafter, hot-pressing the resulted molded body.

A third method of producing a metal member-buried ceramics article according to the present invention for attaining the above-mentioned object comprises providing two AlN sintered bodies having means for suppressing a stress remaining in hot press and providing a metal electrode on either one of the AlN sintered bodies, filling thereon defatted AlN powder and performing first mono-axial press molding, then, providing a metal electric resistor and another AlN sintered body on the press-molded defatted AlN powder and performing second mono-axial press molding, thereafter, hot-pressing the resulted molded body.

It is preferable that the concentration of remaining carbon of the above-mentioned defatted AlN powder is 0.05 to 0.1 wt %.

A fourth method of producing a metal member-buried ceramics article according to the present invention for attaining the above-mentioned object comprises providing two AlN sintered bodies in the form of plate having means for suppressing a stress remaining in hot press and providing between them an AlN calcined body and a metal electrode in contact with the inner surface of one or another AlN sintered body or a metal electrode in contact with the inner surface of one AlN sintered body and a metal electric resistor in contact with the inner surface of another AlN sintered body, and hot-pressing the resulted layered product.

It is preferable that the concentration of remaining carbon of the above-mentioned AlN calcined body is 0.05 to 0.1 wt %.

It is preferable that the above-mentioned means for suppressing a remaining stress gives a proportion of the thickness of the two AlN sintered bodies of 1:1 to 1:4 or 1:10 or more.

According to the metal member-buried ceramics articles and the methods of producing the same of the present invention, two AlN sintered bodies in the form of plate are used and a metal electrode and a metal electric resistor (metal resist exothermic body) are allowed to contact with the inner surface of the AlN sintered body, as a result, distances between the metal electrode, metal electric resistor and AlN sintered body are uniform and adsorption force and distribution of temperature in plane can be made uniform. Since defatted AlN powder and an AlN calcined body are additionally used, impurity oxygen inevitably present in an AlN crystal in calcination and hot pressing is removed by remaining carbon, and production of a metal oxide derived from a metal member is suppressed, pollution of a semiconductor wafer in use can be reduced, and the volume resistivity of an AlN sintered body having a buried metal member can be made uniform, in addition, a stress remaining in hot press can be suppressed, accordingly, warping of the whole body can be suppressed.

### BRIEF DESCRIPTION OF THE DRAWINGS

FIG. 1 is a concept view of a main part showing Example 1 of a metal member-buried ceramics article according to the present invention; and

FIG. 2 is a concept view of a main part showing Example 5 of a metal member-buried ceramics article according to the present invention.

### DESCRIPTION OF THE PREFERRED EMBODIMENTS

In the first and second metal member-buried ceramics articles, it is preferable that the crystal particle size of the upper and lower layers is 6 to 10 μm, the crystal particle size of the intermediate connecting layer is 3 to 7 μm, and irregularity of the average crystal particle size in the same layer is ±1 μm.

It is preferable that the AlN sintered body in the form of plate has a degree of flatness of 30 μm or less.

In the first case, when the thickness of the intermediate connecting layer is less than 0.5 mm, molding in mono-axial press molding is difficult and yield thereof is poor. On the other hand, when over 10 mm, a difference in density between the center part and peripheral parts of a molded body in mono-axial press molding increases, and a difference in density depending on places occurs in a molded body composed of a defatted AlN powder layer after hot press. In the first case, the thickness of the intermediate connecting layer is more preferably from 1 to 5 mm.

In the second case, when the thickness of the intermediate connecting layer is less than 2 mm, handling lowers. On the other hand, when over 20 mm, cracking easily occurs. In the second case, the thickness of the intermediate connecting layer is more preferably from 2.5 to 10 mm.

For connecting by hot press, the metal electrode is preferably composed of W (tungsten), Mo (molybdenum) or Ta (tantalum), or a metal compound thereof having high melting temperature, and of them, a compound composed of W, Mo having thermal expansion coefficient near that of AlN is more preferable since occurrence of cracking in sintering is little with this compound.

Any metal electrodes in the form of plate having no pore, plate of lattice shape, and mesh obtained by knitting a metal wire are used, and they have partially pores for feeding power, pores for gas permeation, and the like from the standpoint of function.

On the other hand, the metal electric resistor is preferably composed of W, Mo.

Any metal electric resistors in the form of plate having no pore, plate of lattice shape, and mesh obtained by knitting a metal wire are used, and they have partially pores for feeding powder, pores for gas permeation, and the like from the standpoint of function.

When the concentration of oxygen solid-soluted in an AlN crystal in the intermediate connecting layer is over 0.5 wt %, irregularity of about two digits order occurs in the volume resistivity of the intermediate connecting layer, and the tone of the intermediate connecting layer becomes black.

When the proportion of the thickness of an upper layer to the thickness of a lower layer is out of the range of 1:1 to 1:4 or 1:10 or more, the degree of flatness is over 50 μm and warping of a metal member-buried ceramics article increases. Any values over 1:10 are permissible, however, in view of application, those of about 1:200 or lower are practical.

When the thickness of the whole body of a metal member-buried ceramics article is 15 mm or less, it is desirable that the thickness of an AIN sintered body of the lower layer is 1, if the thickness of an AlN sintered body of the upper layer is 1, since then a remaining stress occurring between an AlN sintered body, defatted AlN powder and AlN calcined body can be made uniform.

In the first, second and third methods of producing a metal member-buried ceramics article, the defatted AlN powder contains Y (yttrium) as a sintering aid, and the Y content is 10 wt % or less in terms of Y₂O₃ (yttrium oxide).

In the first method, pressure in mono-axial press molding is from 100 to 1500 kg/cm² (more preferably, 150 to 400 kg/cm²).

When pressure in mono-axial press molding is less than 100 kg/cm², a connecting part of an AlN sintered body and a connecting part of defatted AlN powder are not connected sufficiently, causing cracking and lamination.

In the second and third cases, pressure in first mono-axial press molding is 10 MPa (101.972 kg/cm²) or more (more preferably, 10 to 15 MPa), pressure in second mono-axial press molding is 30 MPa (305.916 kg/cm²) or more (more preferably, 30 to 50 MPa), and pressure in second mono-axial press molding is twice or more (more preferably, 2 to 5 times) of pressure in first mono-axial press molding.

When pressure in first mono-axial press molding is less than 10 MPa, a connecting part of an AlN sintered body and a connecting part of defatted AlN powder are not connected sufficiently, causing cracking and lamination. Likewise, also when pressure in second mono-axial press molding is less than 30 MPa and when a difference between pressure in first mono-axial press molding and pressure in second mono-axial press molding is less than twice, a connecting part of an AlN sintered body and a connecting part of defatted AlN powder are not connected sufficiently, causing cracking and lamination.

The sintering temperature in hot press is from 1700 to 1900° C. (more preferably, from 1750 to 1850° C.), pressure is from 0.05 to 0.3 ton/cm² (more preferably, from 0.1 to 0.2 ton/cm²), and keeping time at the maximum temperature is from 1 to 15 hours (more preferably, from 3 to 10 hours). When the concentration of remaining carbon of defatted AlN powder is less than 0.05 wt %, there is a function that carbon reacts with impurity oxygen inevitably present in an AlN crystal, and impurity oxygen is removed in the form of CO (carbon monoxide) or CO₂ (carbon dioxide) out of the system, however, an effect of removing impurity oxygen in an AlN crystal is not obtained. On the other hand, when over 0.1 wt %, a harmful influence of oxidation is imparted on a metal member when a metal member is buried and hot-pressed, and the metal member does not play a role on an electrode or electric resistor.

In the fourth method of producing a metal member-buried ceramics article, an AlN calcined body has higher strength when calcination temperature is higher, and at 1400° C. or more, improvement in handling is remarkable, but a metal member-buried ceramics article produced from an AlN calcined body at 1500° C. seems to change color.

The calcination temperature of an AlN calcined body is from 1000 to 1400° C. (more preferably, from 1100 to 1350° C.).

The degree of flatness of an AlN calcined body is preferably 30 μm or less.

The sintering temperature in hot press is from 1700 to 1900° C. (more preferably, from 1750 to 1850° C.), pressure is from 0.05 to 0.3 ton/cm² (more preferably, from 0.1 to 0.2 ton/cm²), and keeping time at the maximum temperature is from 1 to 15 hours (more preferably, from 3 to 10 hours).

When the concentration of remaining carbon of an AlN sintered body is less than 0.05 wt %, there is a function that carbon reacts with impurity oxygen inevitably present in an AlN crystal, and impurity oxygen is removed in the form of CO (carbon monoxide) or CO₂ (carbon dioxide) out of the system, like the above-mentioned case of defatted AlN powder, however, an effect of removing impurity oxygen in an AlN crystal is not obtained. On the other hand, when over 0.1 wt %, a harmful influence of oxidation is imparted on a metal member when a metal member is buried and hot-pressed, and the metal member does not play a role on an electrode or electric resistor.

When the proportion of the thickness of two AlN sintered bodies is out of the range of 1:1 to 1:4 or 1:10 or more, the degree of flatness is over 50 μm and warping of a metal member-buried ceramics article increases. Any values over 1:10 are permissible, however, in view of application, those of about 1:200 or lower are practical.

### EXAMPLES

### Example 1

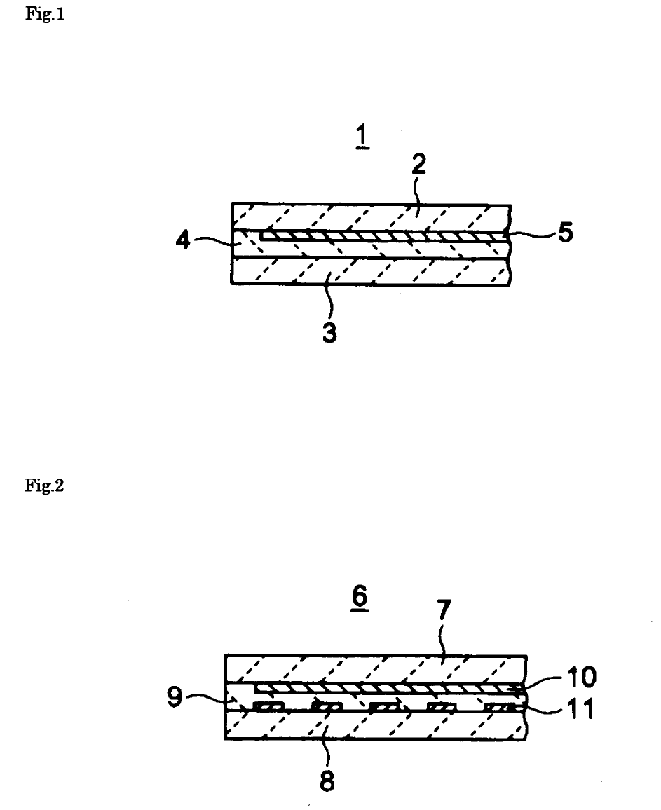

FIG. 1 is a concept view of a main part showing Example 1 of a metal member-buried ceramics article according to the present invention.

This metal member-buried ceramics article 1 is used as an electrostatic chuck, and has a three layer structure in which, between an upper layer 2 and a lower layer 3 composed of an AlN sintered body in the form of plate, an intermediate connecting layer 4 having a thickness of 0.5 to 10 mm composed of a sintered body of defatted AlN powder and a metal electrode 5 in contact with the inner surface of the upper layer 2 are sandwiched, and the proportion of the thickness of the upper layer 2 and the lower layer 3 is controlled at 1:1 to 1:4 or 1:10 or more as means for suppressing a remaining stress occurring between the intermediate connecting layer 4 and the upper and lower layers 2, 3 in sintering defatted AlN powder.

As the metal electrode, any of a plate having no pore, plate of lattice shape and mesh obtained by knitting a metal wire made of W, Mo or Ta or a metal compound thereof having high melting temperature are used, and they have partially pores for feeding power, pores for gas permeation, and the like from the standpoint of function.

The metal electrode 5 is not limited to the case in contact with the inner surface of the upper layer 2, and may contact with the inner surface of the lower layer 3.

For producing the above-mentioned metal member-buried ceramics article, first, 0.5 parts by weight of Y₂O₃ powder as a sintering aid and 100 parts by weight of methanol as a dispersing medium were added to 100 parts by weight of a raw material powder of AlN, and they were crushed and mixed for 18 hours in a ball mill using a polyethylene pot and AlN balls, thereafter, a methanol solution of polyvinyl butyral as a binder was weighed so that the amount of a polyvinyl butyral resin was 4 parts by weight and added, they were further mixed in a ball mill for 1 hour to give a slurry which was spray-dried to give a granulated powder having a particle size of about 1000 μm.

Next, the above-mentioned AlN granulated powder was molded by CIP (pressure: 1000 kg/cm²), defatted, then, sintered at temperatures of 1750 to 1900° C. in a N₂ gas (nitrogen gas) atmosphere, and processed to give a sintered body having a diameter of 340 mm, a thickness of 20 mm and a degree of flatness of 30 μm or less.

On the other hand, the above-mentioned AlN granulated powder was defatted at temperatures of 400 to 700° C. in air to obtain defatted AlN powder.

Then, an AlN sintered body, Mo mesh (wire diameter 0.12 mm, #50) as a metal electrode, defatted AlN powder and AlN sintered body were charged in this order into a mold, and subjected to mono-axial press molding at a pressure of 100 to 1500 kg/cm² to produced a laminate.

Next, the laminate was placed in a carbon jig having a degree of flatness of 30 μm or less, and hot-pressed while changing sintering temperature, keeping time and pressure as shown in Table 1 under a N₂ gas atmosphere, to obtain various metal member-buried ceramics articles.

An upper portion as an insulating dielectric layer of the resulted various metal member-buried ceramics articles was ground to give a thickness of 1 mm, the ground portion was cut, and irregularity in thickness at an interval of 10 mm along crossing X direction and Y direction was checked by a two dimensional measuring apparatus, to obtain results as shown in Table 1.

Further, the density of an intermediate connecting layer obatained by sintering defatted AlN powder after hot press, and presence absence of peeling and cracking at a connecting interface were checked to give results as shown in Table 1.

TABLE 1

| | | | Irregularity in thickness of | | Density of defatted | Peeling and cracking | |
|---|---|---|---|---|---|---|---|
| HP sintering | Keeping | Pressure | dielectric layer | | AlN powder part | at connecting | |
| temperature | time | ton/cm² | X direction | Y direction | after sintering | interface | Judge |
| 1650° C. | 1 | 0.1 | ◯ | ◯ | X | ◯ | X |
| | | 0.2 | ◯ | ◯ | X | ◯ | X |
| | 3 | 0.1 | ◯ | ◯ | X | ◯ | X |
| | | 0.2 | ◯ | ◯ | X | ◯ | X |
| | 5 | 0.1 | ◯ | ◯ | X | ◯ | X |
| | | 0.2 | ◯ | ◯ | X | ◯ | X |
| 1700° C. | 1 | 0.1 | ◯ | ◯ | Δ | ◯ | Δ |
| | | 0.2 | ◯ | ◯ | Δ | ◯ | Δ |
| | 3 | 0.1 | ◯ | ◯ | Δ | ◯ | Δ |
| | | 0.2 | ◯ | ◯ | Δ | ◯ | Δ |
| | 5 | 0.1 | ◯ | ◯ | Δ | ◯ | Δ |
| | | 0.2 | ◯ | ◯ | Δ | ◯ | Δ |
| 1750°c | 1 | 0.1 | ◯ | ◯ | Δ | ◯ | Δ |
| | | 0.2 | ◯ | ◯ | Δ | ◯ | Δ |
| | 3 | 0.1 | ◯ | ◯ | ◯ | ◯ | ◯ |
| | | 0.2 | ◯ | ◯ | ◯ | ◯ | ◯ |
| | 5 | 0.1 | ◯ | ◯ | ◯ | ◯ | ◯ |
| | | 0.2 | ◯ | ◯ | ◯ | ◯ | ◯ |
| 1800° C. | 1 | 0.1 | ◯ | ◯ | Δ | ◯ | Δ |
| | | 0.2 | ◯ | ◯ | Δ | ◯ | Δ |
| | 3 | 0.1 | ◯ | ◯ | ◯ | ◯ | ◯ |
| | | 0.2 | ◯ | ◯ | ◯ | ◯ | ◯ |
| | 5 | 0.1 | ◯ | ◯ | ◯ | ◯ | ◯ |
| | | 0.2 | ◯ | ◯ | ◯ | ◯ | ◯ |
| 1850° C. | 1 | 0.1 | ◯ | ◯ | Δ | ◯ | Δ |
| | | 0.2 | ◯ | ◯ | Δ | ◯ | Δ |
| | 3 | 0.1 | ◯ | ◯ | ◯ | ◯ | ◯ |
| | | 0.2 | ◯ | ◯ | ◯ | ◯ | ◯ |
| | 5 | 0.1 | ◯ | ◯ | ◯ | ◯ | ◯ |
| | | 0.2 | ◯ | ◯ | ◯ | ◯ | ◯ |

* Evaluation standards
Irregularity of dielectric layer:
1 mm ± 0.2 mm or less → ◯
over 1 mm ± 0.3 mm → X
Density of sintered body:
Apparent density: 3.27 g/cm³ or more → ◯
Apparent density: 3.26 g/cm³ or more to less than 3.27 g/cm³ → Δ
Apparent density: less than 3.26 g/cm³ → X
Cracking
None → ◯
Present → X
Judge
◯ → good
Δ → partially unsatisfactory
X → unsatisfactory

For comparison, the same metal electrode as in Example 1 was provided between defatted AlN powder and defatted AlN powder, and they were subjected to mono-axial press molding in the same manner as in Example 1, then, hot-pressed under conditions shown in Table 2 to obtain various metal member-buried ceramics articles, then, irregularity in the thickness of a dielectric layer, density of defatted AlN powder after sintering and presence or absence of peeling and cracking at a connecting interface were checked in the same manner as in Example 1 to give results as shown in Table 2.

TABLE 2

| | | | Irregularity in thickness of | | Density of defatted AlN | Peeling and cracking | |
|---|---|---|---|---|---|---|---|
| HP sintering | Keeping | Pressure | dielectric layer | | powder part after | at connecting | |
| temperature | time | ton/cm² | X direction | Y direction | sintering | interface | Judge |
| 1700° C. | 3 | 0.1 | X | X | Δ | ◯ | X |
| 1750° C. | 3 | 0.1 | X | X | X | ◯ | X |
| 1800° C. | 3 | 0.1 | X | X | X | ◯ | X |

* Evaluation standards are as in Table 1.

As is known from Tables 1 and 2, the case of providing the same metal electrode as in Example 1 between defatted AlN powder and defatted AlN powder is not preferable, and a good connected body is obtained when a metal electrode is provided between an AlN sintered body and defatted AlN powder, they are subjected to mono-axial press molding, and hot-pressed at a sintering temperature of 1750° C. or more for a keeping time of 3 hours or more.

### Example 2

Various metal member-buried ceramics articles were obtained in the same manner as in Example 1 except that the hot press conditions included a sintering temperature of 1800° C., a keeping time of 3 hours and a pressure of 0.1 ton/cm², and the proportion of an upper layer as a dielectric layer and a lower layer as a base layer was changed as shown in Table 3, as a result, the degree of flatness of a connected body, and the like were as shown in Table 3.

Further, a metal electrode was buried in defatted AlN powder and hot-pressed to produce a metal member-buried ceramics article, and an AlN sintered body in the form of plate, metal electrode and defatted AlN powder were charged in this order into a mold and subjected to mono-axial press molding, then, hot-pressed to produced a metal member-buried ceramics article, and the degree of flatness and the like of these ceramics articles were charged to give results as shown in Table 3.

TABLE 3

| | Thickness | | | | | | | | | |
|---|---|---|---|---|---|---|---|---|---|---|
| Ratio of | of | Thickness | Thickness | | | | | Density | Peeling | |
| thickness | dielectric | of defatted | of base | | | Degree of flatness | | of | and | |
| dielectric | layer | powder | side | Irregularity in thickness | | of connected body | | defatted | cracking | |
| layer: | sintered | sintered | sintered | of dielectric layer | | Dielectric | Rear | powder | of | |
| base | body | part | body | X | Y | layer | surface | after | connecting | |
| layer | mm | mm | mm | direction | direction | side | side | sintering | interface | Judge |
| Defatted | 1 | 2 | 1 | X | X | ◯ | ◯ | X | ◯ | X |
| AlN | | | | | | | | | | |
| powder | | | | | | | | | | |
| only 1) | | | | | | | | | | |
| One side | 1 | 2 | 1 | ◯ | ◯ | Δ | Δ | ◯ | ◯ | Δ |
| sintered | | | | | | | | | | |
| body 2) | | | | | | | | | | |
| 1:1 | 0.5 | 2 | 0.5 | ⊚ | ⊚ | ⊚ | ⊚ | ◯ | ◯ | ⊚ |
| 1:2 | | | 1 | ◯ | ◯ | ◯ | ◯ | ◯ | ◯ | ◯ |
| 1:4 | | | 2 | ◯ | ◯ | Δ | Δ | ◯ | ◯ | Δ |
| 1:6 | | | 3 | ◯ | ◯ | X | X | ◯ | ◯ | X |
| 1:8 | | | 4 | ◯ | ◯ | X | X | ◯ | ◯ | X |
| 1:10 | | | 5 | ◯ | ◯ | Δ | Δ | ◯ | ◯ | Δ |
| 1:20 | | | 10 | ◯ | ◯ | ◯ | ◯ | ◯ | ◯ | ◯ |
| 1:60 | | | 30 | ⊚ | ⊚ | ⊚ | ⊚ | ◯ | ◯ | ⊚ |
| 2:1 | 1 | 2 | 0.5 | ◯ | ◯ | ◯ | ◯ | ◯ | ◯ | ◯ |
| 1:1 | | | 1 | ⊚ | ⊚ | ⊚ | ⊚ | ◯ | ◯ | ⊚ |
| 1:2 | | | 2 | ◯ | ◯ | ◯ | ◯ | ◯ | ◯ | ◯ |
| 1:3 | | | 3 | ◯ | ◯ | ◯ | ◯ | ◯ | ◯ | ◯ |
| 1:4 | | | 4 | ◯ | ◯ | Δ | Δ | ◯ | ◯ | Δ |
| 1:5 | | | 5 | ◯ | ◯ | X | X | ◯ | ◯ | X |
| 1:10 | | | 10 | ◯ | ◯ | Δ | Δ | ◯ | ◯ | Δ |
| 1:30 | | | 30 | ⊚ | ⊚ | ⊚ | ⊚ | ◯ | ◯ | ⊚ |
| 3:1 | 1.5 | 2 | 0.5 | ◯ | ◯ | ◯ | ◯ | ◯ | ◯ | ◯ |
| 1:1 | | | 1.5 | ⊚ | ⊚ | ⊚ | ⊚ | ◯ | ◯ | ⊚ |
| 1:2 | | | 3 | ◯ | ◯ | ◯ | ◯ | ◯ | ◯ | ◯ |
| 1:3 | | | 4.5 | ◯ | ◯ | ◯ | ◯ | ◯ | ◯ | ◯ |
| 1:4 | | | 6 | ◯ | ◯ | ◯ | Δ | Δ | ◯ | Δ |
| 1:5 | | | 7.5 | ◯ | ◯ | ◯ | X | X | ◯ | X |
| 1:10 | | | 15 | ◯ | ◯ | ◯ | ◯ | ◯ | ◯ | ◯ |
| 1:15 | | | 22.5 | ⊚ | ⊚ | ⊚ | ⊚ | ◯ | ◯ | ⊚ |

Degree of flatness of connected body
30 μm or less → ⊚
50 μm or less → ◯
50 to 100 μm → Δ
100 μm or more → X
1) connected body manufactured by burying an electrode in powder and hot-pressing the powder
2) connected body manufactured by charging an AlN sintered body, electrode and powder into a mold, subjecting them to mono-axial molding and hot-pressing the molded body

As is known from Table 3, warping of the whole body can be suppressed to 100 μm or less by controlling the proportion of the thickness of an upper layer as a dielectric layer to the thickness of a lower layer as a base layer in the range of 1:1 to 1:4 or 1:10 or more.

### Example 3

First, 3.5 kg of AlN granulated powder obtained in the same manner as in Example 1 was CIP-molded using a rubber mold having a diameter of 450 mm at a pressure of 150 MPa (1530 kg/cm²), and the molded body was defatted in air at a temperature of 600° C. over 5 hours, then, the defatted body was sintered in a N₂ gas atmosphere under normal pressure at a maximum temperature of 1850° C. and subjected to grinding process to obtain an AlN sintered body having a diameter of 300 mm, a thickness of 10 mm and a degree of flatness of 30 μm or less.

On the other hand, the AlN granulated powder was defatted in air at a temperature of 600° C. over a period of 5 hours to obtain defatted AlN powder.

Then, an AlN sintered body, a Mo mesh (wire diameter 0.12 mm, #50) having a diameter of 250 mm as a metal electrode and 700 g of defatted AlN powder were charged in this order into a mold, and subjected to first mono-axial press molding at various pressures shown in Table 4, to produce various first laminates.

Then, the AlN sintered body was placed on each of first laminates and subjected to second mono-axial press molding at various pressures shown in Table 4, to produce various second laminates.

Next, each second laminate was placed in a carbon jig having a degree of flatness of 30 μm or less, and hot-pressed while applying a pressure of 10 MPa for 5 to 10 hours at a temperature of 1800° C. under a N₂ gas atmosphere, to obtain various metal member-buried ceramics articles.

The appearance conditions of the laminate of the resulted various metal member-buried ceramics articles were visually watched and presence or absence of cracking and lamination was observed to obtain results as shown in Table 4, and handling of the laminate was as shown in Table 4.

TABLE 4

| | | | Presence or absence of | | |
|---|---|---|---|---|---|
| Laminate molding pressure | | | cracking and lamination | | |
| First applied | | Second applied | In first | In second | Handling of |
| pressure | | pressure | pressing | pressing | laminate |
| 20 | MPa | 40 MPa | Absent | Absent | Good |
| 10 | MPa | 30 MPa | Absent | Absent | Good |
| 8 | MPa | 30 MPa | Present | Present | Good |
| 10 | MPa | 25 MPa | Absent | Present | Good |
| 20 | MPa | 30 MPa | Absent | Absent | Bad |

As is known from Table 4, cracking and lamination do not occur and handling of a laminate is good when the pressure in first mono-axial press molding is 10 MPa or more, the pressure in second mono-axial press molding is 30 MPa or more and the pressure in second mono-axial press molding is twice or more of the pressure in first mono-axial press molding.

### Example 4

Various metal member-buried ceramics articles were produced in the same manner as in Example 3 except that various defatted AlN powders having different remaining carbon concentrations produced while changing defatting conditions as shown in Table 5 were used, the pressure in first mono-axial press molding was 20 MPa and the pressure in second mono-axial press molding was 40 MPa. Samples having a diameter of 50 mm and a thickness of 2 mm were obtained from a part adjacent to a metal electrode (electrode adjacent part: within 2 mm along the thickness direction from metal electrode) and a part remote from a metal electrode (electrode none-adjacent part: over 5 mm along the thickness direction from metal electrode), and the volume resistivity thereof was measured according to JIS C 2141, the concentration of oxygen in an AlN crystal of an AlN sintered body of the metal electrode-buried part was measure, and the tone of an AlN sintered body of the metal electrode-buried part was visually observed to obtain results as shown in Table 5.

The concentration of remaining carbon of defatted AlN powder was measured by using a carbon-sulfur analyzer (EMIA 220 V) manufactured by HORIBA Ltd.

The concentration of oxygen of an AlN sintered body of a metal electrode-buried part was measured, after grinding a sample in a B₄C mortar, by using an oxygen-nitrogen analyzer (EMGA-620 W) manufactured by HORIBA Ltd.

Regarding the oxygen concentration, the above-mentioned ground powder was subjected to X-ray diffraction measurement to identify second phase components (component in grain boundary layer), as a result, only YAG (3Y₂O₃.5Al₂O₃) was detected. Chemical analysis of this ground powder was conducted by ICP-AES (induced connecting plasma analytical emitting system), as a result, 3800 ppm was detected as Y. It was hypothesized that Y was all present as YAG, and the oxygen amount contained in this YAG was subtracted from the result of measurement of the oxygen concentration of an AlN sintered body, and the resulted value was used as the concentration of oxygen solid-soluted in an AlN crystal, obtained by removing the amount of oxygen contained in a second phase derived from a sintering aid from the amount of oxygen of an AlN sintered body.

TABLE 5

| | | | | Volume resistivity | | | |
|---|---|---|---|---|---|---|---|
| | | | | | Electrode | | |
| Defatting | Defatted carbon | Hot press conditions | | Electrode | non-adjacent | Oxygen | |
| temperature | concentration | Time | Pressure | adjacent part | part | concentration | Tone |
| 600° C. | 0.058 | 5 | 10 | 1.2 × 10¹⁰ | 4.0 × 10¹⁰ | 0.43 | Chinese |
| | | | | | | | yellow |
| 600° C. | 0.054 | 7 | 10 | 3.1 × 10¹⁰ | 2.2 × 10¹⁰ | 0.46 | Chinese |
| | | | | | | | yellow |
| 600° C. | 0.056 | 10 | 10 | 4.8 × 10¹⁰ | 1.5 × 10¹⁰ | 0.45 | Chinese |
| | | | | | | | yellow |
| None | 2.52 | 7 | 10 | 1.1 × 10⁸ | 3.2 × 10¹⁰ | 0.82 | Black |
| 400° C. | 0.134 | 7 | 10 | 4.3 × 10⁸ | 3.8 × 10¹⁰ | 0.59 | Black |
| 500° C. | 0.092 | 7 | 10 | 2.6 × 10¹⁰ | 2.9 × 10¹⁰ | 0.48 | Chinese |
| | | | | | | | yellow |

As is known from Table 5, when the remaining carbon concentration is 0.05 to 0.1 wt %, irregularity of the volume resistivity of an AlN sintered body of a metal electrode-buried part using defatted AlN powder is one digit or less, the concentration of oxygen in an AlN crystal of the AlN sintered body is 0.5 wt % or less, and the tone is Chinese yellow which is an original color of an AlN sintered body.

### Example 5

FIG. 2 is a concept view of a main part showing Example 5 of a metal member-buried ceramics article according to the present invention.

This metal member-buried ceramics article 6 is used as an electrostatic chuck with heater, and has a three layer structure in which, between an upper layer 7 and a lower layer 8 composed of an AlN sintered body in the form of plate, an intermediate connecting layer 9 having a thickness of 2 to 20 mm composed of a sintered body of an AlN calcined body and the same metal electrode 10 as used in Example 1 in contact with the inner surface of the upper layer 7 and a metal electric resistor 11 in contact with the inner surface of the lower layer 8 are sandwiched.

As the metal electric resistor, any of a plate having no pore, plate of lattice shape and mesh obtained by knitting a metal wire made of W or Mo or a metal compound thereof having high melting temperature are used, and they have partially pores for feeding power, pores for gas permeation, and the like from the standpoint of function.

For producing the above-mentioned metal member-buried ceramics article, first, AlN granulated powder obtained in the same manner as in Example 1 was molded by CIP (pressure: 1000 kg/cm²), defatted, then, sintered at temperatures of 1750 to 1900° C. in a N₂ gas atmosphere, and processed to give a sintered body having a diameter of 210 mm, a thickness of 20 mm and a degree of flatness of 30 μm or less.

On the other hand, AlN granulated powder obtained in the same manner as in Example 1 was subjected to mono-axial press molding (pressure: 300 kg/cm²) to obtain a molded body having a diameter of 200 mm and a thickness of 10 mm, defatted in air at a temperature of 600° C., then, the defatted molded body was calcined at temperatures of 700° C., 1100° C., 1200° C., 1300° C., 1400° C. and 1500° C. in vacuo, thereafter, the upper and lower surfaces were processed to give a degree of flatness of 30 μm or less, obtaining various calcined bodies.

Next, the AlN sintered body was placed in a carbon jig having a degree of flatness of 30 μm or less, and on this AlN sintered body, a metal electric resistor composed of Mo, various AlN calcined bodies having changed calcination temperatures, a metal electrode composed of a mesh (wire diameter: 0.12 mm, #50) of Mo and the AlN sintered body were placed in this order, and hot-pressed in a N₂ gas atmosphere at various sintering temperatures of 1700° C., 1750° C. and 1800° C. under a pressure of 0.1 ton/cm², to obtain various metal member-buried ceramics articles.

An upper portion as an insulating dielectric layer of the resulted various metal member-buried ceramics articles was ground to give a thickness of 1 mm, the ground portion was cut, and irregularity in the thickness at an interval of 10 mm along crossing X direction and Y direction was checked by a two dimensional measuring apparatus, to obtain results as shown in Table 6.

The above-mentioned AlN granulated powder was subjected to mono-axial press molding (pressure: 300 kg/cm²) to obtain a disc having a diameter of 27 mm and a thickness of 24 mm, and calcined at temperatures of 700° C., 1100° C., 1200° C., 1300° C., 1400° C. and 1500° C. in air to produce AlN calcined bodies, and the compression strength thereof was measured to give results as shown in Table 6.

Further, the density of an intermediate connecting layer composed of an AlN calcined body after hot press, presence or absence of peeling and cracking at a connecting interface and presence or absence of discoloration were checked to give results as shown in Table 6.

TABLE 6

| | | | | Strength of | Density of | | | |
|---|---|---|---|---|---|---|---|---|
| | | Irregularity in thickness | | calcined | sintered body | Peeling and | | |
| Electrode | Hot press | of dielectric layer | | body | of | cracking at | Presence or | |
| burying | sintering | X | Y | (molded | intermediate | connecting | absence of | |
| method | temperature | direction | direction | body) | layer | interface | discoloration | Judge |
| Connecting | 1700° C. | 1 ± 0.2 | 1 ± 0.2 | X | X | Absent | present | X |
| of calcined | 1750° C. | 1 ± 0.2 | 1 ± 0.2 | | ◯ | Absent | Absent | Δ |
| body at | 1800° C. | 1 ± 0.3 | 1 ± 0.3 | | ◯ | Absent | Absent | Δ |
| 700° C. | | | | | | | | |
| Connecting | 1700° C. | 1 ± 0.2 | 1 ± 0.2 | Δ | X | Absent | Present | X |
| of calcined | 1750° C. | 1 ± 0.2 | 1 ± 0.2 | | ◯ | Absent | Absent | ◯ |
| body at | 1800° C. | 1 ± 0.3 | 1 ± 0.3 | | ◯ | Absent | Absent | ◯ |
| 1100° C. | | | | | | | | |
| Connecting | 1700° C. | 1 ± 0.2 | 1 ± 0.2 | Δ | X | Absent | Present | X |
| of calcined | 1750° C. | 1 ± 0.3 | 1 ± 0.3 | | ◯ | Absent | Absent | ◯ |
| body at | 1800° C. | 1 ± 0.3 | 1 ± 0.3 | | ◯ | Absent | Absent | ◯ |
| 1200° C. | | | | | | | | |
| Connecting | 1700° C. | 1 ± 0.2 | 1 ± 0.2 | Δ | X | Absent | Present | X |
| of calcined | 1750° C. | 1 ± 0.3 | 1 ± 0.3 | | ◯ | Absent | Absent | ◯ |
| body at | 1800° C. | 1 ± 0.3 | 1 ± 0.3 | | ◯ | Absent | Absent | ◯ |
| 1300° C. | | | | | | | | |
| Connecting | 1700° C. | 1 ± 0.2 | 1 ± 0.2 | ◯ | X | Absent | Absent | X |
| of calcined | 1750° C. | 1 ± 0.3 | 1 ± 0.3 | | ◯ | Absent | Absent | ◯ |
| body at | 1800° C. | 1 ± 0.3 | 1 ± 0.3 | | ◯ | Absent | Present | ◯ |
| 1400° C. | | | | | | | | |
| Connecting | 1700° C. | 1 ± 0.2 | 1 ± 0.2 | ⊚ | X | Present | Absent | X |
| of calcined | 1750° C. | 1 ± 0.3 | 1 ± 0.3 | | ◯ | Absent | Absent | ◯ |
| body at | 1800° C. | 1 ± 0.3 | 1 ± 0.3 | | ◯ | Absent | Absent | ◯ |
| 1500° C. | | | | | | | | |

Strength: ⊚ = 2 MPa or more, ◯ = 1 to 2 MPa, Δ = 0.1 to 1 MPa, X = 0.1 MPa or less
Density: ◯ = apparent density: 3.27 g/cm³ or more, Δ = apparent density: 3.26 g/cm³ or more to less than 3.27 g/cm³, X = apparent density: less than 3.26 g/cm³

For comparison, the same metal electrode and metal electric resistor as in Example 3 were provided between defatted AlN powder and defatted AlN powder, and they were subjected to mono-axial press molding in the same manner as in Example 1, then, hot-pressed under the same conditions as in Example 3 to obtain various metal member-buried ceramics articles, then, irregularity in the thickness of a dielectric layer, compression strength of an AlN calcined body, density of an intermediate connecting layer composed of an AlN calcined body after hot press, and presence or absence of peeling and cracking at a connecting interface and presence or absence of discoloration were checked to give results as shown in Table 7.

The AlN granulated powder and defatted AlN powder were subjected to mono-axial press molding (pressure: 300 kg/cm²) to obtain a disc having a diameter of 27 mm and a thickness of 24 mm, and calcined at various temperatures to produce AlN calcined bodies, and the compression strength thereof was measured to give results as shown in Table 7.

TABLE 7

| | | | | | | | Presence | |
|---|---|---|---|---|---|---|---|---|
| | | | | Strength of | | | or | |
| | | Irregularity in thickness | | calcined | Density of | Peeling and | absence | |
| | Hot press | of dielectric layer | | body | sintered body | cracking at | of | |
| Electrode burying | sintering | X | Y | (molded | of intermediate | connecting | discolora- | |
| method | temperature | direction | direction | body) | layer | interface | tion | Judge |
| Defatted powder | 1700° C. | 1 ± 0.9 | 1 ± 0.9 | X | Δ | Absent | Present | X |
| molded body | 1750° C. | 1 ± 0.9 | 1 ± 0.9 | | ◯ | Absent | Absent | X |
| (mono-axial | 1800° C. | 1 ± 1.0 | 1 ± 1.0 | | ◯ | Absent | Absent | X |
| molding pressing | | | | | | | | |
| method) | | | | | | | | |
| Molded body | — | — | — | Δ | — | — | — | — |
| (mono-axial | | | | | | | | |
| molding pressing | | | | | | | | |
| method) | | | | | | | | |

Strength: ⊚ = 2 MPa or more, ◯ = 1 to 2 MPa, Δ = 0.1 to 1 MPa, X = 0.1 MPa or less
Density: ◯ = apparent density: 3.27 g/cm³ or more, Δ = apparent density: 3.26 g/cm³ or more to less than 3.27 g/cm³, X = apparent density; less than 3.26 g/cm³

AS is known from Tables 6 and 7, a good connected body is obtained when an AlN calcined body and a metal electrode and metal electric resistor are provided between AlN sintered bodies and hot-pressed at a sintering temperature of 1750° C. or more.

Higher the calcination temperature, higher the strength of an AlN calcined body, and particularly, at temperatures of 1400° C. or more, improvement in handling is remarkable.

A metal member-buried ceramics article obtained by using an AlN calcined body calcined at a temperature of 1500° C. seems to discolor.

In Examples 1 to 4 described above, three layer structures sandwiching an intermediate connecting layer and metal electrode between an upper layer and a lower layer have been described, however, the present invention is not limited to them, and a three layer structure sandwiching an intermediate connecting layer, metal electrode and metal electric resistor between an upper layer and a lower layer may also be used as in Example 5.

Example 5 is not limited to a three layer structure sandwiching an intermediate connecting layer, metal electrode and metal electric resistor between an upper layer and a lower layer, and three layer structures sandwiching an intermediate connecting layer and metal electrode between an upper layer and a lower layer as in Examples 1 to 4 may also be adopted.

In this case, a metal electrode may be in contact with the inner surface of any of an upper layer and a lower layer.

1. A metal member-buried ceramics article having a three layer structure comprising an upper layer composed of an AlN sintered body in the form of plate, a lower layer composed of an AlN sintered body in the form of plate and an intermediate connecting layer having a thickness of 0.5 to 10 mm composed of a sintered body of defatted AlN powder formed between the upper layer and lower layer composed of an AlN sintered body in the form of plate, and a metal electrode in contact with the inner surface of the upper layer or lower layer or a metal electrode in contact with the inner surface of the upper layer and a metal electric resistor in contact with the inner surface of the lower layer sandwiched between them, and having means for suppressing a stress remaining in sintering the defatted AlN powder.

2. A metal member-buried ceramics article having a three layer structure comprising an upper layer composed of an AlN sintered body in the form of plate, a lower layer composed of an AlN sintered body in the form of plate and an intermediate connecting layer having a thickness of 2 to 20 mm composed of a sintered body of an AlN calcined body in the form of plate formed between the upper layer and lower layer composed of an AlN sintered body in the form of plate, and a metal electrode in contact with the inner surface of the upper layer or lower layer or a metal electrode in contact with the inner surface of the upper layer and a metal electric resistor in contact with the inner surface of the lower layer sandwiched between them, and having means for suppressing a stress remaining in sintering the AlN calcined body.

3. The metal member-buried ceramics article according to claim 1, wherein the concentration of oxygen solid-soluted in an AlN crystal in the intermediate connecting layer is 0.5 wt % or less.

4. The metal member-buried ceramics article according to claim 1, wherein the means for suppressing a remaining stress gives a proportion of the thickness of the upper layer to the thickness of the lower layer of 1:1 to 1:4 or 1:10 or more.

5. The metal member-buried ceramics article according to claim 3, wherein the means for suppressing a remaining stress gives a proportion of the thickness of the upper layer to the thickness of the lower layer of 1:1 to 1:4 or 1:10 or more.

6. A method of producing a metal member-buried ceramics article, comprising providing two AlN sintered bodies in the form of plate having means for suppressing a stress remaining in hot press and providing between them defatted AlN powder and a metal electrode in contact with the inner surface of one or another AlN sintered body or a metal electrode in contact with the inner surface of one AlN sintered body and a metal electric resistor in contact with the inner surface of another AlN sintered body, subjecting the resulted layered product to mono-axial press molding, then, hot-pressing the layered product.

7. A method of producing a metal member-buried ceramics article, comprising providing two AlN sintered bodies in the form of plate having means for suppressing a stress remaining in hot press and providing a metal electrode on either one of the AlN sintered bodies, filling thereon defatted AlN powder and performing first mono-axial press molding, then, providing another AlN sintered body on the press-molded defatted AlN powder and performing second mono-axial press molding, thereafter, hot-pressing the resulted molded body.

8. A method of producing a metal member-buried ceramics article, comprising providing two AlN sintered bodies having means for suppressing a stress remaining in hot press and providing a metal electrode on either one of the AlN sintered bodies, filling thereon defatted AlN powder and performing first mono-axial press molding, then, providing a metal electric resistor and another AlN sintered body on the press-molded defatted AlN powder and performing second mono-axial press molding, thereafter, hot-pressing the resulted molded body.

9. The method of producing a metal member-buried ceramics article according to claim 6, wherein the concentration of remaining carbon of the defatted AlN powder is 0.05 to 0.1 wt %.

10. A method of producing a metal member-buried ceramics article, comprising providing two AlN sintered bodies in the form of plate having means for suppressing a stress remaining in hot press and providing between them an AlN calcined body and a metal electrode in contact with the inner surface of one or another AlN sintered body or a metal electrode in contact with the inner surface of one AlN sintered body and a metal electric resistor in contact with the inner surface of another AlN sintered body, and hot-pressing the resulted layered product.

11. The method of producing a metal member-buried ceramics article according to claim 10, wherein the concentration of remaining carbon of the AlN calcined body is 0.05 to 0.1 wt %.

12. The method of producing a metal member-buried ceramics article according to claim 6, wherein the means for suppressing a remaining stress gives a proportion of the thickness of the two AlN sintered bodies of 1:1 to 1:4 or 1:10 or more.

13. The method of producing a metal member-buried ceramics article according to claim 9, wherein the means for suppressing a remaining stress gives a proportion of the thickness of the two AlN sintered bodies of 1:1 to 1:4 or 1:10 or more.

14. The metal member-buried ceramics article according to claim 2, wherein the concentration of oxygen solid-soluted in an AlN crystal in the intermediate connecting layer is 0.5 wt % or less.

15. The metal member-buried ceramics article according to claim 2, wherein the means for suppressing a remaining stress gives a proportion of the thickness of the upper layer to the thickness of the lower layer of 1:1 to 1:4 or 1:10 or more.

16. The method of producing a metal member-buried ceramics article according to claim 7, wherein the concentration of remaining carbon of the defatted AlN powder is 0.05 to 0.1 wt %.

17. The method of producing a metal member-buried ceramics article according to claim 8, wherein the concentration of remaining carbon of the defatted AlN powder is 0.05 to 0.1 wt %.

18. The method of producing a metal member-buried ceramics article according to claim 7, wherein the means for suppressing a remaining stress gives a proportion of the thickness of the two AlN sintered bodies of 1:1 to 1:4 or 1:10 or more.

19. The method of producing a metal member-buried ceramics article according to claim 8, wherein the means for suppressing a remaining stress gives a proportion of the thickness of the two AlN sintered bodies of 1:1 to 1:4 or 1:10 or more.

20. The method of producing a metal member-buried ceramics article according to claim 10, wherein the means for suppressing a remaining stress gives a proportion of the thickness of the two AlN sintered bodies of 1:1 to 1:4 or 1:10 or more.

21. The method of producing a metal member-buried ceramics article according to claim 11, wherein the means for suppressing a remaining stress gives a proportion of the thickness of the two AlN sintered bodies of 1:1 to 1:4 or 1:10 or more.
